(19) United States
(12) Patent Application Publication
(10) Pub. No.: US 2002/0169737 A1
(43) Pub. Date: Nov. 14, 2002

(54) Knowledge management system

(76) Inventors: Charles Allan Armstrong, Toronto (CA); Valdis Edgars Krebs, Westlake, OH (US)

Correspondence Address: Bell Boyd & Lloyd, P.O. Box 1135, Chicago, IL, 60690-1135, US

(21) Appl. No.: 10/138,172

(22) Filed: May 4, 2002

Related U.S. Application Data
(63) Continuation-in-part of application No. 09/706,123, filed on Nov. 3, 2000.

(51) Int. Cl. G06F 17/00

(52) U.S. Cl. 706/59; 706/45

(57) ABSTRACT

The present invention generally relates to knowledge management systems, and more particularly, to a computer-based knowledge management system. In the present description, a knowledge management is described which provides a visual representation of an organization wherein the individuals in the organization are linked to one another through knowledge artefacts. By use of the knowledge artefacts to link individuals, the knowledge management system of the present invention provides for an improved method for visualization of the knowledge exchanges that take place in an organization.

This is a continuation-in-part application of U.S. patent application Ser. No. 09/706,123, filed Nov. 3, 2000.

### FIELD OF THE INVENTION

The present invention generally relates to knowledge management systems, and more particularly, to a computer-based knowledge management system.

### BACKGROUND OF THE INVENTION

The corporate sector has long felt the need for a tool which shows what the corporation “knows”. The theory of knowledge conversion (from tacit to explicit knowledge) has been well-known for years. In practice, however, once tacit knowledge is converted to explicit ‘knowledge’ (and documented), it loses most of its context and immediately begins its degradation into information.

Up until now, the backbone of most self-described ‘knowledge management systems’ has been a searchable database. However, regardless of the usefulness of the objects in the database, this content (reports, documents etc.) is not ‘knowledge’, but low-grade information

The challenge has been to create a knowledge conversion system whereby information achieves a position as high as possible in the “data>information>knowledge” spectrum and undergoes as little degradation as possible. This has not been done before although there have been (and continue to be) many attempts in this area.

For example, in the Information Technology Sector, Comintell's web page system (www.comintell.com) entitled “WhoWhatWhere” is described by the authors as a “self-maintained directory of subject experts”. It is, however, basically an address book with a ‘yellow page’ component that documents the subject's expertise.

In a similar fashion, the system of “Contact Networks” (www.contact.com) imports data from popular address books. The network grows and updates as other “nodes” in the network update their co-ordinates.

While these two systems have some utility, they do not provide a visual representation of the connections between people, nor does it provide the “metrics” that would identify certain individuals as “network hubs”. Further, they are missing a “knowledge artefacts” component, as will be described hereinbelow. Furthermore, the interfaces used may not be browser-based, but may be a downloadable file.

“ThinkMap” (www.thinkmap.com) makes the claim that its system animates data and visually illustrates the relationships that exist between information in a database. Additionally, Thinkmap claims to harness design and technology to forge powerful information tools that empower individuals to transform data into information. However, it is missing a “people” component to describe the relationship of a person to the information. While it claims its product “combines the best attributes of any of the tools on the market for interface authoring, data visualization, and content navigation. . .” it does not tie information to people. Accordingly, regardless of the browsability of data found in the Thinkmap system, the user does not know how that information is being used by others and for what purposes.

NetPerceptions (www.netperceptions.com) system entitled “Knowledge Management 2.0” represents itself as an analysis and reporting tool that helps management understand the relationships between people and knowledge resources by tracking usage. By capturing how people interact with information, the software builds connections so employees can benefit from what others are doing. It is also claimed that the program builds personalized “knowledge cubes” based on relevant relationships between information sources, information objects and people. However, it does not have a user-deployable Web-based interface.

Also, it should be noted that the program utilizes its personalization technology to “find” and “recommend” people or documents. It is therefore claimed that the program “understands” what each user knows and needs to know at any given moment, finds “knowledge neighbours” who do related work and have made similar inquiries, then recommends the documents that the knowledge neighbour has found most valuable. However, it is contended that it is extremely unlikely that a computer system can “understand what each user knows” which is the starting point for the NetPerceptions product.

It is the Applicant's position that knowledge management is more about sharing relevant information, either through socialization, or through use and reuse of knowledge artefacts. Thus, the NetPerceptions product is driving the “knowledge management initiative”, however, it does not provide complete control to the user to study relationships between people and knowledge artefacts.

While these Information Technology approaches to knowledge management have some utility, it would still be desirable to provide a knowledge management system wherein the system would utilize people connections to “point” to proven and peer-evaluated knowledge artefacts that are already being used to support corporate strategy, and to other people who have demonstrated interest or know-how.

Similarly, in the social network world (which includes the academic and corporate sector), there are several products which are related to the present area of interest. However, none of the social network products provide a real-time dynamically generated visualization of relationships between people and/or artefacts. Because these products have been developed or used by social network analysts, they do include algorithms and metrics which are relevant to network analysis.

For example, the following products are currently developed, or under development, by various interest groups in the social network field:

i) “Structure” which is a DOS-based program based on early metrics work;

ii) “KrackPlot” is also DOS-based and uses some annealing algorithms to arrange the graphs. It also contains some metrics that have been found to be useful;

iii) “Yakview” adds a network map view to project management software; and

iv) “Netmap” (www.netmap.com.au) is UNIX based and is really 3-5 programs. The user enters data in one program, analyze it in another, map it out in a third, etc.

Further, the system is not an end-user product. Data is submitted to the program supplier and the results are forwarded back to the user.

However, these social network programs are not generally end-user-deployable; and/or are not Web-based programs; and/or do not include knowledge artefacts as part of their programming because knowledge artefacts are generally not recognized by the social network analysts. Accordingly, these programs do not provide a preferred knowledge management system.

Some programs do attempt to combine the concepts of information technology and social networks together. For example:

i) The Brain (www.thebrain.com) provides an alternative to tree-based visualization systems. In its U.S. Patent (U.S. Pat. No. 6,031,537, assigned to Natrificial LLC), it is stated that their system provides “. . . a method and apparatus for displaying a thought network from a thought's perspective”. This system provides a means to visualize relationships between information, but does not clearly delineate between “artefact owners” and “artefacts” as two, distinct network objects. Accordingly, it is contended that this system is not a preferred knowledge management tool, since it does not provide a visual representation of relationships between people and artefacts (and subsequently developed derived artefacts);

ii) Tacit (www.tacit.com) provides a user profiling system that results in a profile partitioned into “public” and “private” access areas. It is stated that the “right connections are made among people, and between people and content”. Using this system, published profiles live on the corporate Intranet where they can be searched to make people-to-people (and content) connections, as well as propose recipients for e-mail messages or other content. The system fosters a culture of extensive collaboration and sharing, with both the user and the enterprise benefiting enormously.

However, it does not provide a visual component to provide an overview of the system;

iii) “Sixdegrees” (www.Sixdegrees.com) provide a system identified as “ConnectMe” which is allows the user to enter personal information and information related to associates. The program will then create links to known associates. The system then allows the user to establish connections to other users searching for criteria such as desired skills, geographic location, and the like. However, this system is primarily a system for personal contacts, and does not provide for the necessary business focus or knowledge management features desired in business applications; and

iv) “ContactMap” (www.cs.umd.edu/hcil/about/events/history-workshop/slides/Whittaker/index.htm) is an ego-centric application. However, it has no provisions for various combined knowledge management groupings. It is particularly focused on e-mail analysis similar to the approach taken by “tacit.com”, described hereinabove. Also, this program is not Internet “web-enabled”, and does not address privacy issues related to the information contained therein.

Accordingly, these combined systems do not provide for all of the features of a preferred knowledge management system.

Additionally, U.S. Pat. No. 4,974,173 awarded to Xerox in 1990 for “Small-scale workspace representations indicating activities by other users” provides a collaborative system in which a body of shared data may be accessed by more than one user, and may include an indication of the activities of other users. However, the system described is not Java based, is not Web-based, is not user-deployable, and, does not mention relationship mapping, nor relationships with associated artefacts.

Also, patent application No. WO99/30423 filed by AT&T (published Jun. 17, 1999) and entitled “Automatic visualization of managed objects over WWW” provides a system for the visualization of networks. However, there is no reference to “social networks”.

Also, in a newsletter document, entitled “Knowledge Mapping Aids Discovery of Organizational Information”, (The Edge, April 2000, volume 4, Number 1, “www.mitre.org/pubs/edge/”), a system is discussed wherein “knowledge maps” are prepared as visual representations of “knowledge” within an organization. These knowledge maps are prepared using “topic detection technology”, and by relating people in the organization through the key topics detected. However, the use of “topic detection technology” may result in the selection of artificial topics.

Accordingly, while there are numerous knowledge management systems available, there is still a need for an improved system wherein knowledge management, social network analysis, and knowledge network building are combined into a visual, user-deployable, computer-based system, which is preferably available over the Internet, and which links people through properly selected knowledge artefacts.

### SUMMARY OF THE INVENTION

It is an object of the present invention to provide a knowledge management system which provides a visual representation of the knowledge of an organization.

It is a further object of the present invention to provide a knowledge management system which is interactive, so that numerous people within the organization can utilize the system.

It is a still further object of the present invention to provide a knowledge management system which is accessible through an computer system such as an Intranet, or over the Internet.

Additionally, it is a principal object of the present invention to provide a knowledge management system wherein the people in the organization are linked together by knowledge artefacts, wherein the artefacts are selected either as contributed artefacts, or as derived artefacts.

The foregoing objects are attained by providing a computer-based system for recording and displaying knowledge management information in a web-based, interactive fashion wherein people are linked to one another through knowledge artefacts.

Accordingly, the knowledge management system of the present invention provides a Web-based visualization of a relational database that connects information to people and people to information. This simple user-deployable knowledge network map encourages the user to: (1) add nodes; (2) add node-associated “knowledge artefacts”, and (3) create new artefacts that are derivatives of known artefacts.

Thus, the present invention provides an interactive knowledge management which provides a visual representation of an organisation wherein the people of the organisation are linked to one another through knowledge artefacts.

The knowledge artefacts selected may be contributed artefacts, in that they have been established by someone in the organization, or they can be derived artefacts which are developed by review of the existing artefacts. Further, to assist in the creation of new artefacts, a framework called “Artefact Generator”, discussed hereinbelow, can be provided.

Thus, while the data and information that supports this networked model of people and knowledge artefacts resides in a database, the user interface is intuitive and simple, allowing anyone to visualize an organization in terms of its people, its knowledge artefacts, or a combination of people and artefacts.

Where the knowledge management system of the present invention differs from other “knowledge bases” is that the knowledge artefacts are always associated with people, and people, particularly in mature relationships, are almost always associated through knowledge artefacts. The people connections provide invaluable context to the artefacts, and the artefact connections make the knowledge management system of the present invention more than a mere social network map.

It is contended that the act of active, conscious selection of artefact does more to raise the conscious awareness of an organization than to have an artificial topic selected by topic detection technology, as described hereinabove.

For clarity, it should be noted that, within the present system, “knowledge artefacts” are a component of the person-to-person relationship. Similarly, people are components of the artefact-to-artefact relationship, either as primary owners, or as owners of derived artefacts.

### DETAILED DESCRIPTION OF THE INVENTION

The knowledge management system of the present invention is a computer-based system, and preferably, an Internet Web-based system, that allows users to visualize a simple “star network” comprised of personal contacts. A collection of personal networks can be merged together into an aggregated group network, thereby creating a visualization of the knowledge exchanges within an organization. This makes the knowledge management system of the present invention a valuable knowledge management and community building tool.

The knowledge management system is partly an “online address book”, but it is more useful since it also reveals existing and new connections between contacts. However, the system goes beyond depicting relationships between people because it also includes the knowledge artefacts that define the relationships. The system's unique representation of people and their associated knowledge artefacts allows a user to browse through these connections, either to identify people via knowledge artefacts, or discover knowledge artefacts through the people connections. Similarly, it allows anyone to view an organization in terms of its people network or its artefact network through discovery through query.

“Artefacts” are the tangible things people create or use to help them get their work done. When people use artefacts, they build their way of working right into them. An artefact reveals the assumptions, concepts, strategy and structure that guide the people who work with it.

Knowledge artefacts are the explicit documented knowledge that each individual or group contributes to the organizational knowledge pool.

Examples of items which can act as artefacts (or knowledge artefacts) include such items as letters, reports, seminars, presentations, reference articles, patents, lectures, and the like, or representations thereof.

A user does not have to document the artefact extensively. Pointing to the person who influenced you to create the artefact or who should know about the artefact is an integral part of the system. Accordingly, in the network, your pattern of connections reveal who you are and what you are trying to accomplish.

The knowledge artefacts have their own metrics such as, for example, “reach” (an InFlow type of metric). Thus, artefacts can have a measurable “Reach-In” and “Reach-Out”, which is a metric that originated with social networks. Artefacts with a high Reach-In are referenced by other artefacts, who are also highly referenced. A high Reach-Out is achieved by artefacts which reference, or which reach out, to many others who, in turn, are also reaching out to many others.

“Reach” can also be used in both symmetric and asymmetric networks. It is a measure that looks at how well a node is connected by examining the connections of a node's direct and indirect neighbours. The better connected the neighbours, the higher the reach score. Reach can be evaluated and quantified. For example, reach can be expressed in terms of a percentage of nodes reached in a given number of steps. Thus, a Reach2 of 0.25 means that 25% of all other nodes in the network can be reached in 1 or 2 steps. A Reach score of 0 means that a node is not connected at all, and therefore is an isolate. A Reach score of 1.00 means that a node has paths to al other nodes in the network. A Reach4 of 1.00 means that a node can reach all other nodes in the network by paths of length 1, 2, 3 or 4. A node with a Reach4 of 1.00 is much better connected that a node with a Reach4 of 0.45.

Reach-In and Reach-Out look at the directionality of the links in the network. Reach-In only counts arrows pointing in to a node. Reach-Out counts only arrows pointing away from a node. The human nodes also have metrics such as “reach”, in a manner similar to artefacts.

These and other metrics, such as Reach, can be used in the use of the system of the present invention.

It should also be noted that an artefact's status/prestige increases more if the artefact receives references from high status/prestige artefacts. These are ‘opinion leader’ artefacts—their influence ripples throughout the knowledge space surrounding the organization.

Selection of appropriate artefacts can vary depending on the requirements of the user. However, some artefacts are created only after they have been considered in light of a so-called “Artefact Generator”. For the purposes of this document, the Artefact Generator is an interface which provides guidelines for artefact creation. Its primary purpose is to prevent loss of context. Preferably, the Artefact Generator has four major elements, namely:

i) Strategy: What is the importance of the artefact as it relates to the strategic initiatives of the company? It should be noted that a clearly articulated corporate strategy is generally required for relevant context-sensitive knowledge artefact generation;

ii) Ownership: In the case of existing artefacts, this can credit the original author of the artefact. However, artefact usage and reuse is as important, if not more important than, artefact creation. In fact, a primary benefit of the knowledge management system of the present invention is to foster use and reuse of artefacts, and eliminate duplication of effort;

iii) Description: Various tools and probes are used to help articulate the more challenging artefacts. Such probes can include, for example, the use of metaphor, storytelling, line of questioning, as well as different representations such as drawings, audio clips, flow charts, and the like; and

iv) Relationship Identification: This portion of the Artefact Generator evaluates concepts such as, for example: Who accesses the artefact? Which artefacts refer to each other? How is the artefact used by others and with which frequency?

Thus, the Artefact Generator provides another entry point for artefacts to be added to the database of the knowledge management system of the present invention. However, artefacts can be added to the system at the time the people relationships are defined or after they have been evaluated through the Artefact Generator. It should be noted that a primary purpose of the knowledge management system of the present invention is to elicit, share and leverage knowledge artefacts.

The knowledge management system of the present invention is unique because it creates a system that applies existing knowledge management models (whereby intangible assets are visualized as knowledge artefacts) and the principles of social networking (whereby relationships are the principle conduits of knowledge flows) into a unique knowledge network building system. Thus, the knowledge management system of the present invention is the visualization of the knowledge exchanges that take place in an organization.

Accordingly, using the knowledge management system of the present invention provides a unique representation of people and their associated knowledge artefacts in an interactive Web-based interface that allows a user to browse through these connections, either to identify people via knowledge artefacts, or discover knowledge artefacts through the people connections. Viewing a selected knowledge artefact in the display of knowledge management system of the present invention gives the user an understanding of the item's meaning and relevance in the larger system because of an object's connections with other artefacts and the people who use them.

The system thus preferably allows anyone to view an organization in terms of its people network or its artefact network. Unlike databases which are context-poor, the present system is a highly contextualized representation of the knowledge exchanges of an organization because it reveals “who is connected with whom” (expert directory) and “how they are connected” (knowledge artefact). When different types of networks in an organization are made visible (task network, innovation network, trust network), it can also be seen “why they are connected”.

The knowledge management system of the present invention is particularly suited for use over the Internet, wherein various parties in an organization would be able to access and update the information contained in the organization knowledge management database. Preferably, the knowledge management system of the present invention would provide the following features, namely:

i) Intuitive user interface accessible via a Web browser. After user authentication, the user can add, edit and delete nodes from the personal network via a client-side Java applet. The user can view the group or organization network, preferably after various “filters” have been applied to control access to only authorized information.;

ii) Rich information architecture. Nodes can take on unlimited shapes and colours and can even be represented by graphics. The ties between nodes can have varying weights to provide an additional metric to describe the relationship i.e. strong tie, weak tie. Directionality can be used indicate the flow of information between nodes;

iii) Dynamic connections. As new nodes are added to any of the primary nodes, new connections are potentially revealed on a continuous basis. A screen refresh updates the system from the server-side database;

iv) Drill-down capability. Not only can the various relationships be visualized, the nodes are hyperlinked to a ‘yellow page’ which further reveals information about each node; and

v) Multiple views. The user can toggle between the “people view” of the organization and the “artefact view”. Knowledge artefacts can be hidden or revealed. Categories of network relationships can be revealed in stages.

It should also be noted that the knowledge management system of the present invention preferably uses a non-linear information hierarchy based on relationships between the artefact owners and/or various network relationships within an organization. It is relationship-driven (people and knowledge artefacts and their derived artefacts have known relationships), user-driven (the system takes shape based on individual contributions of nodes and knowledge artefacts), and contextual (the relationships elevate the knowledge artefact to a higher position on the data>information>knowledge spectrum).

The system can also lead to a variety of derivative products, such as, for example:

i) A tool to be used by associations of any kind (e.g. politics, industry, business, clubs) to identify network hubs and key influencers;

ii) A tool for genealogy mapping, whereby the “artefacts” might be represented by purses (in the case of thoroughbred racing) or prizes (dog shows);

iii) A tool for “business to business” network mapping, whereby competitors can be identified by certain built-in node attributes, and information can be prevented from being presented to potential business competitors;

iv) A tool for illustrating “value exchanges” wherein value exchanges are the fair exchanges of both tangible and intangible goods, services and benefits; and

v) A tool for educational purposes, such as for depicting the food chain.

The knowledge management system of the present invention is preferably structured in layers so that individuals would have access to their own knowledge management mappings, and would have access to an organization or group knowledge management maps based on the shared information of the individual knowledge management mappings. For example, a representative program on a computer, such as, for example, KNETMAP would be a generic system used to create both MYKNETMAP (a personal KNETMAP) and GROUPKNET which would be a combined mapping based on a series of personal KNETMAPs.

Thus, a GROUPKNET is composed of the combination of various MYKNETMAPs, while a MYKNETMAP is a visual representation of an individual's social relationships within an organization (people-to-people) and their associated knowledge artefacts.

KNETMAP thus provides a collaborative system (GROUPKNET) in which a body of shared data (from combined MYKNETMAPs) may be accessed by more than one user. A small-scale representation of the body of shared data displayed to any user includes an indication of the activities of other users. A user that is not viewing the shared data at full scale can still obtain information about the activities of other users from a small-scale representation (e.g. specific GROUPKNETs or “views” of a GROUPKNET). The small-scale representation can indicate the type of GROUPKNET (e.g. innovation network, marketing network, customer relationship network etc.) and, if on the server (in a client-server computer environment), the GROUPKNET is constantly updated whenever individual MYKNETMAPs are uploaded.

Thus, KNETMAP can be considered as a community building tool. Using the system, an individual will then be known by their relationships to one another and the artefacts that they have contributed to the community and to developing the community.

The system of the present invention, and in particular, KNETMAP, is preferably arranged in a client-server type arrangement wherein the program resides on the main server computer. The user access the program on the server through the client computer. The program then preferably uses Java to display KNETMAP data visualisations on common Web browsers which are accessed by the user. The KNETMAP Client communicates queries to the KNETMAP server using standard HTTP connections. In Intranet applications, the KNETMAP Client can communicate directly with an underlying database.

The KNETMAP User preferably has a user-based system of controls that allows users to fine-tune the information in KNETMAP visualisations in real time. This ability effectively limits the data that appears at any one given time, and makes it more efficient to navigate through large data sets.

A WWW server accepts data from a user in order to produce a visualization of the data (MYKNETMAP). The user can control the visualization algorithm over the network using a JAVA-based user-interface. The visualization can be modified through the inclusion of other data (combining KNETMAPs).

KNETMAP thus offers “data-driven” visualisations that lets users change the attributes of a given GROUPKNET (combined KNETMAPs) based on user-defined values in a data field.

The system can also import MYKNETMAPs from popular address books, handheld devices, etc. into specific GROUPKNETS and updates the GROUPKNET as other MYKNETMAPS are added. GROUPKNET determines who gets to see which portion of a MYKNETMAP.

With KNETMAP the process for knowledge building is clear: the nodes you add are defined by the relationships you hold in differing circumstances (i.e. different types of networks) with people. The artefacts are associated with these relationships. New artefacts are associated with existing artefacts and follow the guidelines of the Artefact Generator.

KNETMAP can also include systems for obtaining and/or updating information from a group or individual. One preferred method for achieving this would be to routinely ask users to identify nodes, groups, individuals and the like, who are useful contacts. This might be accomplished by, for example, routinely asking users a question regarding their contacts on a regular basis, such as every day, week, month, quarter-year, or year. The responses from the users would be used to update and/or amend the relationships of the users. By determining this information on a regular basis, the relationships are constantly updated, and therefore, reflect the current situation.

Thus, in a preferred feature, users are asked to identify nodes, groups, individuals and the like, who are useful contacts, on a regular basis in order to update or amend the relationships of the users. This is preferably conducted by asking users to answer a specific question designed to elicit information regarding the contacts of the user. In a most preferred embodiment of this feature, users are asked to answer a specific question every week.

KNETMAP has algorithms and metrics but a primary feature of this product is that it presents a visualization of the knowledge exchanges that take place in an organization through the relationships between people and/or knowledge artefacts. Additional metrics can add value to KNETMAP for a wide variety of purposes, but preferably, the program is primarily used as a knowledge network building and visualizing system.

KNETMAP aggregates social network relationship information and associated knowledge artefacts and stores it as a file containing a list of attributes for creating an HTML page viewable from any WWW browser. The data is reconfigurable and shows up as different GROUPKNET visualisations. The appropriate page and appropriate Java applet(s) are retrieved to a Web browser.

KNETMAP is thus, a user-friendly interface for viewing the aggregation of organization information. This has the advantage that it allows aggregation of personal information into group-accessible information to reduce the complexity and provide a distributed services model that allows the visualization of rich data types for competitive advantage.

Accordingly, in a preferred embodiment, KNETMAP is a knowledge management tool that visualizes relevant relationships between people and their associated knowledge artefacts. It can generate different KNETMAPs representing different “views” of the same source data. Its unique representation of people and their associated knowledge artefacts allows the KNETMAP user to “browse” these connections, either to identify people via knowledge artefacts or identify new knowledge artefacts through the people connections (and possibly generating new knowledge artefacts). Thus, KNETMAP depicts representations of knowledge geography, such as knowledge artefacts, and derived knowledge artefacts.

Preferably, KNETMAP is capable of being inverted/flipped in order to visualize the same organization [of people] in terms of their knowledge artefacts. Further, KNETMAP preferably additionally has specific “social” network mapping features, such as symbols, variegated tie weights, embedded metrics, e-mail links, URL links, and the like

By capturing how people interact with information, and how they share k-artefacts, the system of the present invention can foster a culture of extensive collaboration and sharing, with both users and the organization benefiting enormously.

KNETMAP tracks subject experts and enables subject experts in an organization to know about each other's skills so they can easily create useful GROUPKNETs themselves; KNETMAP matches subjects with knowledge artefacts and personal profiles (KNETPAGES).

In a preferred feature, the system of the present invention (e.g. KNETMAP) has unique network profiling that results in the profile being partitioned into “personal” (also known as “private”) and “public” nodes as designated by the user. Any nodes designated “personal/private” do not get combined into the viewable GROUPKNET.

Network profiles live on the corporate Intranet where they can be searched to make people-to-people and/or content-to-content and/or people-to-content connections.

In order to search for relevant connections between people, between artefacts, and between people and artefacts, a database “search engine” and/or taxonomic classification system pick list is typically used.

However, the system of the present invention can allow for searching by several mechanisms, such as, for example: (1) form-based field search; (2) browsing through the KNETMAP connections; and (3) using external search engines.

The system of the present invention preferably provides an integration layer which connects to a wide variety of knowledge sources, including groupware and document management systems. The objects (specifically knowledge artefacts) preferably have metrics which indicate the artefact's history (who viewed it, who downloaded it, who has referenced it).

Thus, KNETMAP, for example, can be integrated with a document management system, wherein the document management system has a “history” feature for files which identifies who viewed a document, who down loaded it and when, etc. Thus, the system of the present invention can be made compatible as a third-party add-on to any suitable document management systems.

Thus, the system, and in particular, KNETMAP, preferably provides the foundation of transparent access to autonomous, and heterogeneous knowledge repositories and a powerful, flexible, Web-based, user-deployable organization system via its form-based JAVA applet. Additionally, GROUPKNETs, through various combinations of MYKNETMAPs, are capable of representing and integrating numerous knowledge resources via a database distributed over the network.

Further, the system, and in particular, KNETMAP, through its visualization of social relationships and knowledge artefacts, fosters a synergistic symbiosis between information technology and organizational context. “Who” uses “what” and “what else is referenced” and “in what context” forms the basis of a fairly accurate representation of the dynamics of any organization.

Other features of the present invention, as well as other objects and advantages attendant thereto, are set forth in the following description and the accompanying drawings in which like reference numerals depict like elements.

### BRIEF DESCRIPTION OF THE DRAWINGS

A preferred embodiment of the knowledge management system of the present invention will now be described by reference to the following drawings wherein:

FIG. 1 is a view of a screen showing a simple representation of a knowledge map according to the present invention for one person;

FIG. 2, is a view of the same information shown in FIG. 2, but wherein the information is present in a different format, by artefacts; and

FIG. 3, is a representation of an organization knowledge map which has been assembled from a variety of individual knowledge maps.

Unless otherwise stated, like numbers indicate common features, or the same feature repeated from one drawing to another.

### DETAILED DESCRIPTION OF A PREFERRED EMBODIMENT

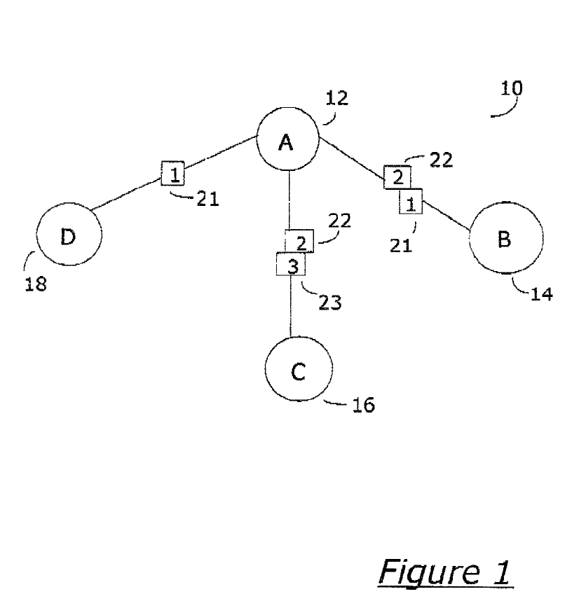

In FIG. 1, a diagram representing a simple knowledge management view according to the present invention is shown. The view (10) represents the knowledge management map for an individual “A” (12), and was prepared using the computer program KNETMAP, as described hereinabove. The view (10) is thus, a representation of a MYKNETMAP display for person “A”.

In FIG. 1, it can be seen that individual “A” (12) has connections to individuals “B”, “C” and “D” (14, 16 and 18 respectively) through artefacts 1, 2 and 3 (21, 22 and 23 respectively). It should be noted that various individuals in this view may be connected by the same artefact. For example, individual “A” (12) is linked to individual “B” (14) by artefact 1 (21) and artefact 2 (22), to individual “C” by artefacts 2 (22) and 3 (23), and to individual “D” by artefact 1 (21).

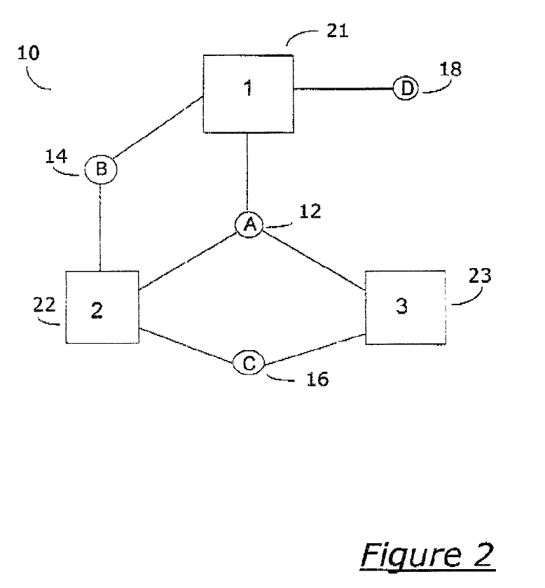

In FIG. 2, the same information is presented as in FIG. 1, but in this example, the information has been sorted by artefact. In this view, it can clearly be seen how the individuals are linked to one another by artefacts “1”, “2” and “3”.

It should be noted that each of individuals “A”, “B”, “C” and “D” would each have their own MYKNETMAP and would have links to other individuals through the same, or other artefacts.

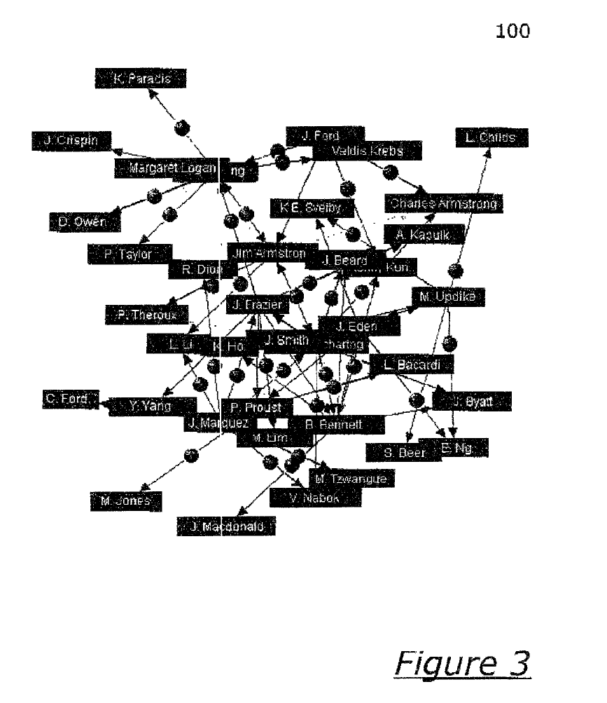

In FIG. 3, a knowledge management mapping for an organization (100) is shown which represents a GROUPKNET based on the collected KNETMAPs for all of the individuals in the organization, which are shown as rectangles. It should be noted that all of the connections between individuals are through artefacts, which are shown as circles.

From this view, it can be established, either visually, or by searching with a search engine, how individuals are connected within the organization. A similar view of the organization could be prepared by sorting the information in FIG. 3 so as to be sorted by artefacts.

Thus, it is apparent that there has been provided, in accordance with the present invention, a knowledge management system of the present invention which fully satisfies the means, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

The embodiments of the invention in which an exclusive property or privilege is claimed are defined as follows:

1. A computer-based system for recording and displaying knowledge management information for an organization of people, wherein people are displayed as being linked to other people in the organization, characterized in that the people in the organization are linked to one another through knowledge artefacts.

2. A system as claimed in claim 1 wherein said knowledge artefacts are selected by a conscious selection of artefacts.

3. A system as claimed in claim 1 wherein said knowledge artefacts are letters, reports, seminars, presentations, reference articles, patents and lectures, or representations thereof.

4. A system as claimed in claim 1 wherein said knowledge artefacts are contributed artefacts, or are derived artefacts.

5. A system as claimed in claim 1 wherein artefacts are added to the system at the time the people relationships are defined, or after the artefacts have been evaluated through the Artefact Generator.

6. A system as claimed in claim 1 wherein said knowledge artefacts are derived artefacts which have been created using an Artefact Generator.

7. A system as claimed in claim 6 wherein said Artefact Generator is an interface which provides guidelines for artefact creation.

8. A system as claimed in claim 6 wherein said Artefact Generator comprises four major elements, namely, strategy, ownership, description, and relationship identification.

9. A system as claimed in claim 1 wherein said computer-based system is Internet-based.

10. A system as claimed in claim 9 wherein said computer-based system is accessed through an Internet connection.

11 A system as claimed in claim 10 wherein said computer-based system is accessed through said Internet connection in an interactive fashion.

12. A system as claimed in claim 1 wherein said system is structured in layers comprising a plurality of individual knowledge management mappings showing links between an individual and other individuals through knowledge artefacts, and an organization layer created by collecting two or more individual knowledge mappings together to assemble a knowledge management mapping for the organization.

13. A system as claimed in claim 12 wherein an individual's knowledge management mapping can be imported into the system electronically from an electronic address book or handheld device.

14. A system as claimed in claim 1 wherein users are asked to identify nodes, groups, individuals and the like, who are useful contacts, on a regular basis in order to update or amend the relationships of the users.

15. A system as claimed in claim 14 wherein said users are asked to identify useful contacts by answering a specific question designed to elicit information regarding the contacts of the user.

16. A system as claimed in claim 15 wherein said users are asked to answer a specific question every week.

17. A system as claimed in claim 1 wherein the information related to people in the organization or the knowledge artefacts, is searchable.

18. A system as claimed in claim 17 wherein the people in the organization and said knowledge artefacts are searchable by a search engine.

19. A system as claimed in claim 1 wherein the organization can be visualized in terms of its people network or its artefact network.

20. A system as claimed in claim 1 wherein said system additionally provides social network mapping features

21. A system as claimed in claim 20 wherein said social network mapping features are symbols, variegated tie weights, embedded metrics, e-mail links and URL links.

22. A system as claimed in claim 1 wherein said system additionally comprises a document management system, or is compatible with document management systems of other software products.
